(19) United States
(12) Patent Application Publication
(10) Pub. No.: US 2018/0035039 A1
(43) Pub. Date: Feb. 1, 2018

(54) Wearable Police Camera with Remote Activation and Positional Awareness

(71) Applicant: MPAS, LLC, Carrollton, TX (US)

(72) Inventors: Steve Spalding, Carrollton, TX (US); Parks McGregor, Lewisville, TX (US)

(73) Assignee: MPAS, LLC, Carrollton, TX (US)

(21) Appl. No.: 15/597,472

(22) Filed: May 17, 2017

Related U.S. Application Data
(60) Provisional application No. 62/368,720, filed on Jul. 29, 2016.

(51) Int. Cl. H04N 5/232; H04N 5/907; G01P 15/18; G01S 19/13; G01C 9/00; H04N 7/18; H04N 5/77

(52) U.S. Cl. CPC H04N 5/23206; H04N 7/185; H04N 5/907; H04N 5/772; G01S 19/13; G01C 9/00; G01P 15/18

(57) ABSTRACT

The present invention relates to wearable, remotely operable security camera equipment. Specifically, the present invention relates to a police camera with remote activation of the record feature. The invention also includes positional awareness for activation.

### CROSS-REFERENCE TO RELATED APPLICATIONS

This application makes reference for priority to U.S. Prov. Pat. App. No. 62/368720 filed Jul. 29, 2016 and incorporates it in its entirety by reference.

### FIELD OF THE INVENTION

The present invention relates to wearable, remotely operable security camera equipment. Specifically, the present invention relates to a police camera with remote activation of the record feature. The invention also includes positional awareness for activation.

### BACKGROUND OF THE INVENTION

Currently, there are numerous police cameras worn as part of law enforcement officer's apparel. The most common variant is a clip-on version that is worn on the officer's upper body area such as a shoulder or a chest. These camera systems present numerous technical innovations. However, there is no product that incorporates both automatic (remote) activation of the record phase of the camera and positional (attitudinal) activation of the record phase of the camera.

Thus, it is a first goal of the present invention to provide a wearable security camera that is remotely activated by the dispatcher of the call.

It is a second goal of the present invention to provide a wearable security camera that is automatically activated by the position (attitude) of the camera as it is worn by the police officer.

### SUMMARY OF THE INVENTION

The exemplary embodiment of the present invention comprises two components: 1) A wearable wireless digital camera; and, 2) A remote activation application running on a computer for managing and activating the camera as it is worn.

The wearable wireless digital camera is contained in a lightweight housing with a mounting clip attached. The lightweight housing of the wearable wireless digital camera is generally rectilinear in shape. The mounting clip is attached to the back of the wearable wireless digital camera body and is rotatable with respect to the center point of the wearable wireless digital camera housing such that the clip may be rotated an arbitrary amount to form any angle with respect to the housing of the wearable wireless digital camera. The mounting clip allows the officer to affix the wearable wireless digital camera to his or her clothing.

The wearable wireless digital camera comprises the following external features: 1) A camera lens; 2) A microphone; 3) A large distress button; 4) A smaller power button mounted on the side of the device; 5) A power on indicator lamp; 6) A recording on indicator lamp; 7) A low power indicator lamp; 8) An annunciator indicting that the device is being used to record images; 9) A mounting clip; and, 10) A docking port.

Internally, the wearable wireless digital camera comprises the following components: 1) A camera associated with the camera lens; 2) An accelerometer/inclinometer; 3) A GPS receiver; 4) A wireless data transceiver; 5) A processor; 6) A battery; and, 7) RAM/ROM memory.

The wearable wireless digital camera contains a software program that coordinates and controls its functions. The software program is stored in the ROM portion of the memory, executes on the processor, and stores results in the RAM/ROM portion of the memory.

Ordinarily, the wearable wireless digital camera is worn clipped to the shirt or other external garment or accessory worn by the officer.

The wearable wireless digital camera is used in the following manner:

When the wearable wireless digital camera is not being worn, it is stored in a docking station wherein the docking port is attached to external power so that the battery in the wearable wireless digital camera is kept at a constant charge level. Simultaneously, the docking port is attached such that an external computing device accesses the imagery and audio recorded in the memory of the wearable wireless digital camera. The imagery and audio is collected and stored externally to the wearable wireless digital camera. Simultaneously, the docking port is attached such that an external computing device accesses the ROM portion of memory and the software program resident in the wearable wireless digital camera is updated if necessary.

When the wearable wireless digital camera is first worn the device is in idle state. None of the indicator lamps are illuminated (unless the device's battery is at or below the preset minimum battery charge whereupon the low power indicator lamp is illuminated). Pressing the power button changes the state of the device from idle state to baseline state. In baseline state the power on indicator lamp is illuminated (and the low power indicator lamp is illuminated if the battery is below the device's preset low power setting). Also, the device's GPS coordinates are recorded to the RAM/ROM memory. Also, the device's inclination is monitored. Pressing the device's power button in baseline state for a period of time exceeding several seconds—typically 3 seconds, but adjustable up to 15 seconds—transitions the device back to idle state.

In idle state pressing the distress button first changes the state of the device to baseline state and begins the recording of video from the camera and audio from the microphone. In baseline state pressing the distress button begins the recording of video from the camera and audio from the microphone. Recorded video and audio is stored in the RAM/ROM portion of memory along with the geographic coordinates read from the GPS device. In both cases, the recording on indicator lamp is illuminated. Similarly, the annunciator indicating that recording is occurring is illuminated (if the annunciator is illuminable). Pressing the device's distress button while recording in baseline state for a period of time exceeding several seconds—typically 3 seconds, but adjustable up to 15 seconds—transitions the device to non-recording state. Similarly, the recording on indicator lamp is turned off and the annunciator indicating that recording is occurring is turned off (if the annunciator may be illuminated).

In baseline state any tilting of the device beyond a preset level—typically 30°, but adjustable to 50°—above horizontal begins recording of video from the camera and audio from the microphone along with the geographic coordinates read from the GPS device. Any such deviation from vertical is caused by the officer being at or near horizontal on the ground such as might be encountered in a struggle or if the officer is disabled.

Ordinarily, however the device is caused to record by the command of a dispatcher. In this mode the device is in baseline state and the dispatcher acts wirelessly by means of the data transceiver to cause the device to transition to recording state. As above, recorded video and audio is stored in the RAM portion of memory along with the geographic coordinates read from the GPS device. In both these cases, the recording on indicator lamp is illuminated. Similarly, the annunciator indicating that recording is occurring is illuminated (if the annunciator may be illuminated). After the dispatcher has concluded, the dispatcher acts wirelessly by means of the data transceiver to cause the device to stop recording and return to non-recording state.

### BRIEF DESCRIPTION OF THE DRAWINGS

FIG. 1 is a perspective diagram showing the front of the wearable wireless digital camera.

FIG. 2 is a perspective diagram showing the rear of the wearable wireless digital camera.

FIG. 3 is a diagram illustrating the components comprising the wearable wireless digital camera.

### DETAILED DESCRIPTION OF THE PREFERRED EMBODIMENT

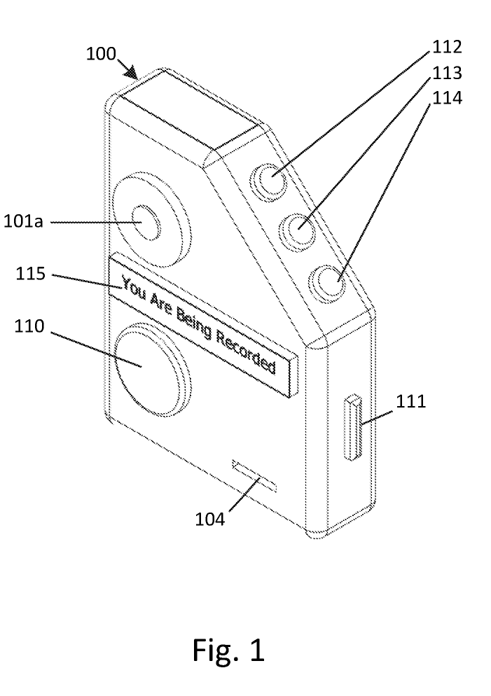

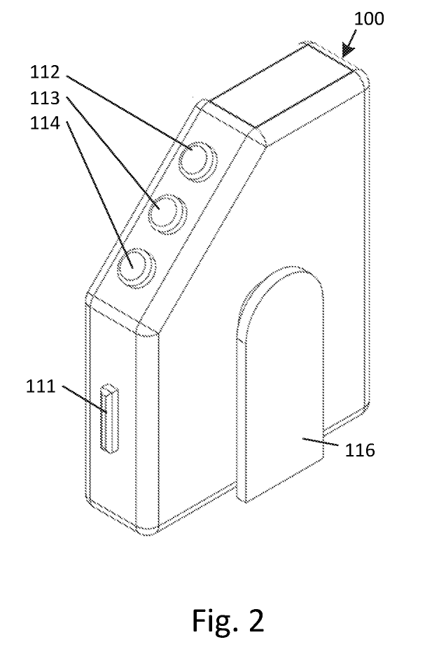

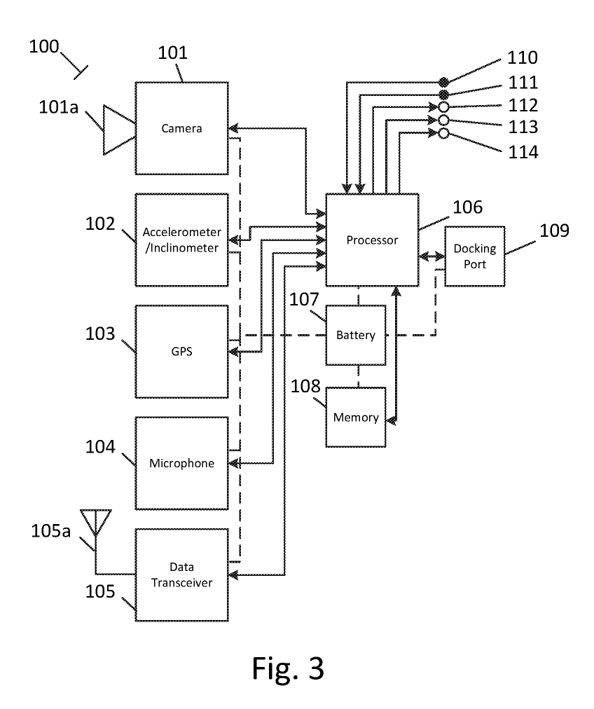

Referring now to FIGS. 1, 2, and 3, wearable wireless digital camera 100 is contained in a lightweight housing with mounting clip 116 attached. Lightweight housing with mounting clip 116 are constructed of plastic, polycarbonate, or metal. The lightweight housing of the exemplary version of wearable wireless digital camera 100 is generally rectilinear in shape. Those having skill in the art will recognize that wearable wireless digital camera 100 may be constructed in any shape. Similarly, wearable wireless digital camera 100 may be constructed in any combination of devices.

Mounting clip 116 is attached to the back of wearable wireless digital camera 100 body and is rotatable with respect to the center point of the wearable wireless digital camera 100 housing such that mounting clip 116 may be rotated an arbitrary amount to form any angle with respect to the housing of wearable wireless digital camera 100. Mounting clip 116 allows the officer to affix wearable wireless digital camera 100 to his or her clothing.

The exemplary version of wearable wireless digital camera 100 comprises the following external features: 1) Camera lens 101a (associated with camera 101); 2) Microphone 104; 3) Large distress button 110; 4) Smaller power button 111 mounted on the side of wearable wireless digital camera 100; 5) Power on indicator lamp 112; 6) Recording on indicator lamp 113; 7) Low power indicator lamp 114; 8) Illuminable annunciator indicating that recording is occurring 115; 9) Mounting clip 116; and, 10) A docking port 109 (ordinarily mounted on the bottom edge of wearable wireless digital camera 100).

Internally, wearable wireless digital camera 100 comprises the following components: 1) Camera 101 (associated with camera lens 101a); 2) Accelerometer/inclinometer 102; 3) GPS receiver 103; 4) Wireless data transceiver 105 (and associated antenna 105a); 5) Processor 106; 6) Battery 107; and, 7) RAM/ROM memory 108.

Camera 101 is comprised of a charge coupled device (CCD) or complementary metal oxide semiconductor (CMOS) device. The exemplary version of camera 101 has a resolution of 640×480 pixels, but those having skill in the art will recognize that any resolution may be used.

Microphone 104 is comprised of an externally mounted, acoustically transparent port and an internal transducer. In the exemplary version of the present invention, the internal transducer is an electret condenser microphone. Those having skill in the art will recognize that there are numerous other electroacoustic transducers that may be freely interchanged.

Accelerometer/inclinometer 102 is comprised in the exemplary version of the device as a tilt sensor. Those having skill in the art will recognize that any three-dimensional positioning sensor may be used. Accelerometer/inclinometer 102 is used to determine if the wearer of wearable wireless digital camera 100 is at or near a horizontal location as might be encountered in a struggle or if the officer is disabled. In the exemplary embodiment of the present invention, whether the officer is horizontal is determined by whether the officer is less than 30° (but adjustable to 50°) above horizontal.

GPS receiver 103 may receive GPS or GLONASS signals or some combination of both. Those having skill in the art will recognize that numerous competitive satellite technologies and systems exist and that any of these are acceptable substitutes.

Wireless data transceiver 105 (and associated antenna 105a) may be of any type. The exemplary embodiment of the invention comprises a cellular data transceiver and antenna. GSM, CDMA, and their technological successors are all acceptable alternatives.

In the exemplary embodiment of the present invention processor 106 is an ARM-based microprocessor. Intel and other processors are also acceptable alternatives.

In the exemplary embodiment of the present invention, battery 107 ordinarily supplies electrical power to camera 101, accelerometer/inclinometer 102, GPS receiver 103, microphone 104, wireless data transceiver 105, processor 106, and RAM/ROM memory 108. Battery 107 may be of any type including lithium ion.

In the exemplary embodiment of the present invention, illuminable annunciator indicating that recording is occurring 115 comprises an LED backlighting a plastic mounting clip overlaid with a printed notification that recording is occurring. Those have skill in the art will recognize that the printed notification may be in any language and may contain symbols. Similarly, those having skill in the art will recognize that illuminable annunciator indicating that recording is occurring 115 may in fact not be illuminable.

In the exemplary embodiment, docking port 109 is provided on the bottom edge of wearable wireless digital camera 100. Docking port 109 provides electrical connections for power and data transmission. Those having skill in the art will recognize that both power and data transmission may occur wirelessly.

Wearable wireless digital camera 100 contains a software program that coordinates and controls its functions. The software program is stored in the ROM portion of memory 108, executes on processor 106, and stores program data and results in the RAM/ROM portion of memory 108.

Ordinarily, wearable wireless digital camera 100 is worn clipped to the shirt or other external garment or accessory worn by the officer. The officer actuates mounting clip 116 to spring its terminal edge out away from the housing of wearable wireless digital camera 100. The officer then secures mounting clip 116 over a strap or cloth fastening point on the outer surface of the officer's clothing.

Wearable wireless digital camera 100 is used in the following manner:

When wearable wireless digital camera 100 is not being worn, it is stored in a docking station wherein docking port 109 is attached to external power so that battery 107 in wearable wireless digital camera 100 is kept at a constant charge level. Simultaneously, docking port 109 is attached such that an external computing device accesses the imagery and audio recorded in the memory of wearable wireless digital camera 100. The imagery and audio is collected and stored externally to wearable wireless digital camera 100. Simultaneously, docking port 109 is attached such that an external computing device accesses the ROM portion of memory 108 and the software program resident in wearable wireless digital camera 100 is updated if necessary.

When wearable wireless digital camera 100 is first worn the device is in idle state. None of the indicator lamps are illuminated (unless the device's battery is at or below the preset minimum battery charge whereupon low power indicator lamp 114 is illuminated). Pressing smaller power button 111 changes the state of the device from idle state to baseline state. In baseline state power on indicator lamp 112 is illuminated (and low power indicator lamp 114 is illuminated if the battery is below the device's preset low power setting). Also, processor 106 reads GPS receiver 103 to determine the device's geographic coordinates and records them to RAM/ROM memory 108. Also, the device's accelerometer/inclinometer 102 is monitored. Also, a status signal may be transmitted to the dispatcher. Pressing smaller power button 111 in baseline state for a period of time exceeding several seconds—typically 3 seconds, but adjustable up to 15 seconds—transitions the device back to idle state. Also, a status signal may be transmitted to the dispatcher.

In idle state pressing large distress button 110 first changes the state of the device to baseline state and begins the recording of video from camera 101 and audio from microphone 104. In baseline state pressing large distress button 110 begins the recording of video from camera 101 and audio from microphone 104. Recorded video and audio is stored in the RAM/ROM portion of memory 108 along with the geographic coordinates read from GPS receiver 103. In both cases, recording on indicator lamp 113 is illuminated. Similarly, annunciator indicating that recording is occurring 115 is illuminated (if the annunciator may be illuminated). Also, a status signal may be transmitted to the dispatcher. Pressing large distress button 110 while recording in baseline state for a period of time exceeding several seconds—typically 3 seconds, but adjustable up to 15 seconds—transitions the device to non-recording state. Similarly, recording on indicator lamp 113 is turned off and the annunciator indicating that recording is occurring 115 is turned off (if the annunciator is illuminated). Also, a status signal may be transmitted to the dispatcher.

In baseline state any tilting of the device beyond a preset level—typically 30°, but adjustable to 50°—above horizontal begins recording of video from camera 101 and audio from microphone 104 along with the geographic coordinates read from GPS receiver 103. Any such deviation from vertical is caused by the officer being at or near horizontal on the ground such as might be encountered in a struggle or if the officer is disabled. Also, if this occurs a status signal may be transmitted to the dispatcher.

Ordinarily, however wearable wireless digital camera 100 is caused to record by the command of a dispatcher. In this mode the wearable wireless digital camera 100 is in baseline state and the dispatcher acts wirelessly by means of wireless data transceiver 105 to cause wearable wireless digital camera 100 to transition to recording state. As above, recorded video and audio is stored in the RAM portion of memory 108 along with the geographic coordinates read from GPS receiver 103. In both these cases, recording on indicator lamp 113 is illuminated. Similarly, annunciator indicating that recording is occurring 115 is illuminated (if the annunciator may be illuminated). Also, if this occurs a status signal may be transmitted to the dispatcher. After the dispatcher has concluded recording, the dispatcher acts wirelessly by means of wireless data transceiver 105 to cause the device to stop recording and return to non-recording state. Also, if this occurs a status signal may be transmitted to the dispatcher.

While the present invention has been described in what are thought to be the most useful and practical embodiments, it will be readily apparent to those having skill in the art that other variations may be readily conceived and created. Accordingly, these and all such other readily conceived and created variations are implicitly included in the spirit and scope of the present disclosure.

What is claimed is:

1. A wearable wireless digital camera comprising:
a) a digital camera;
b) a microphone;
c) a GPS receiver;
d) an accelerometer/inclinometer;
e) a wireless data transceiver;
f) a processor;
g) ROM/RAM memory;
h) a battery;
i) a docking port with data communication and electrical leads;
j) where the digital camera, the microphone, the GPS receiver, the accelerometer/inclinometer, the wireless data transceiver, and the data communication leads of the docking port are in bidirectional data communication with the processor and the processor is in bidirectional data communication with the ROM/RAM memory; and
k) where the battery supplies electrical power to the electrical devices comprising the wearable wireless digital camera and the battery may be recharged by means of the electrical leads in the docking port; and
l) where the wireless data transceiver may command the processor to record video data from the camera and store it in the RAM/ROM memory while simultaneously transmitting it to a remote observer via the wireless data transceiver.

2. A wearable wireless digital camera of claim 1 where the processor may be commanded to record audio data from the microphone and store it in the RAM/ROM memory while simultaneously transmitting it to a remote listener via the wireless data transceiver.

3. A wearable wireless digital camera of claim 1 where the processor may be commanded to simultaneously record audio data from the microphone and record video data from the camera and store them in the RAM/ROM memory while simultaneously transmitting them to a remote listener via the wireless data transceiver

4. A wearable wireless digital camera of claim 1 wherein the contents of the ROM/RAM memory may be accessed and changed by the processor.

5. A wearable wireless digital camera of claim 4 wherein the contents of the ROM/RAM memory may be accessed and changed by means of the data communication leads of the docking port.

6. A wearable wireless digital camera of claim 4 wherein the contents of the ROM/RAM memory may be accessed and changed by means of the wireless data transceiver.

7. A wearable wireless digital camera of claim 1 further comprising a software program capable of recording video, audio, and GPS coordinates to the ROM/RAM memory.

8. A wearable wireless digital camera of claim 6 further comprising a software program capable of accessing the wireless data transceiver to determine if the dispatcher has issued a command to begin recording audio, video, and GPS coordinates to the ROM/RAM memory.

9. A wearable wireless digital camera of claim 6 further comprising a software program capable of reading the accelerometer/inclinometer to determine if the wearer is positioned horizontally to begin recording audio, video, and GPS coordinates to the ROM/RAM memory.
